(19) United States
(12) Patent Application Publication
(10) Pub. No.: US 2014/0319196 A1
(43) Pub. Date: Oct. 30, 2014

(54) STAPLE CARTRIDGE FOR TACKER

(71) Applicant: TSUNG- WEN HUANG, Changhua COUNTY (TW)

(72) Inventor: TSUNG- WEN HUANG, Changhua COUNTY (TW)

(21) Appl. No.: 13/870,869

(22) Filed: Apr. 25, 2013

(51) Int. Cl. B25C 5/16

(52) U.S. Cl. CPC B25C 5/1637
USPC 227/120

(57) ABSTRACT

A staple cartridge for a tacker includes two side plates with a bottom plate connected therebetween to form the U-shaped staple cartridge. Each side plate has a front end and each front end has a guide portion protruding from outside thereof. Each guide portion has a guide face facing toward a front direction of the side plate and the guide face of each guide portion is an inclined face relative to the front end. The staples are guided by the guide faces to move in straight so as to easily staple the object.

### FIELD OF THE INVENTION

The present invention relates to a staple cartridge of a tacker, and more particularly, to a staple cartridge having two guide portions on two respective outsides of the front ends of the side plates so as to guide the staples to move in straight.

### BACKGROUND OF THE INVENTION

The conventional tacker is elongate and flat, a U-shaped staple cartridge is installed to a slot defined in the lower end of the tacker. A pushing plate is mounted to the staple cartridge and biased by a spring so as to push the inverted U-shaped staples mounted to two side plates of the staple cartridge to be pushed toward the outlet located at the front end of the tacker. The staples are pushed downward by the striking plate and penetrate through the object located beneath the outlet.

The conventional staple cartridge is designed for the long staples which have longer legs. However, when in use, short staples are needed to staple the object and the short staples are installed to the staple cartridge. There are different requirements for properly positioning the short staples on the conventional staple cartridge. The conventional staple cartridge 70 is disclosed in FIGS. 7 and 8 and generally comprises two side plates 71 which form the U-shaped staple cartridge 70. Each of the two side plates 71 has a recess 73 defined in the front end 72 thereof, and the recesses 73 are located close to the outlet of the tacker. A connection plate 74 is located between the two front ends 72 of the two side plates 71. A guide plate 80 is connected between the two front ends 72 and two first protrusions 81 respectively extend from top portions of the two sides of the guide plate 80. Two second protrusions 82 respectively extend from lower portions of the two sides of the guide plate 80, each second protrusion 82 has an inclined face 83. The first protrusions 81 are engaged with the recesses 73, and the guide plate 80 is connected to the connection plate 74. A guide surface is then formed between the front ends 72 of the side plates 71 and the guide plate 80. The inclined faces 83 of the second protrusions 82 are located below the side plates 71 of the staple cartridge 70, so that the staples in the staple cartridge 70 can be ejected out from the outlet to staple the object.

As mentioned before, the staple cartridge 70 and the side plates 71 are designed for the long staples, so that the travel between the object and the staples is short. The two legs of the staples are quickly guided by the second protrusions 82 to contact the paper sheets. The inclined faces 83 guide the staples to move in straight to staple the paper sheets. However, when the short staples are used, there is a distance different between the legs of the short staples and the side plates 71, in order to guide the short staples to move in straight during the longer travel, the inclined faces 83 have to guide the short staples to move in straight to staple the paper sheets.

The side plates of the conventional staple cartridge have to be pressed with the recesses, and the connection plate is needed to be located between the two side plates. A guide plate is then connected to the two front ends of the side plates. The guide plate has to be pressed with the second protrusions. There are too many parts and manufacturing steps involved and high manufacturing cost is expected.

The conventional staple cartridge needs the guide plate to be connected to the two side plates, and the guide plate has to be stably connected to the side plates and has a proper guide surface. This makes the manufacturing steps for the conventional staple cartridge be complicated and time-consuming.

The present invention intends to provide a staple cartridge of a tacker to improve the shortcomings of the conventional staple cartridge.

### SUMMARY OF THE INVENTION

The present invention relates to a staple cartridge for a tacker and comprises two side plates with a bottom plate connected therebetween to form the U-shaped staple cartridge. Each side plate has a front end and each front end has a guide portion protruding from outside thereof. Each guide portion has a guide face facing toward a front direction of the side plate and the guide face of each guide portion is an inclined face relative to the front end.

Preferably, the guide face of each guide portion is an inclined face relative to the front end.

Preferably, each guide portion is a triangular prism.

Preferably, the lower end of each guide portion is in flush with the front end corresponding thereto.

The primary object of the present invention is to provide a staple cartridge for a tacker and the staples are guided by the guide faces to move in straight to easily staple the object.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the tacker and the staple cartridge of the present invention;

FIG. 2 is a perspective view to show the staple cartridge of the present invention;

FIG. 3 is a side view to show that long staples are positioned to the staple cartridge of the present invention;

FIG. 4 is a perspective view to show that short staples are positioned to the staple cartridge of the present invention;

FIG. 5 is a side view to show that the short staples are positioned to the staple cartridge of the present invention;

FIG. 6 shows that the short staple is stapled to an object;

FIG. 7 is an exploded view to show the conventional staple cartridge, and

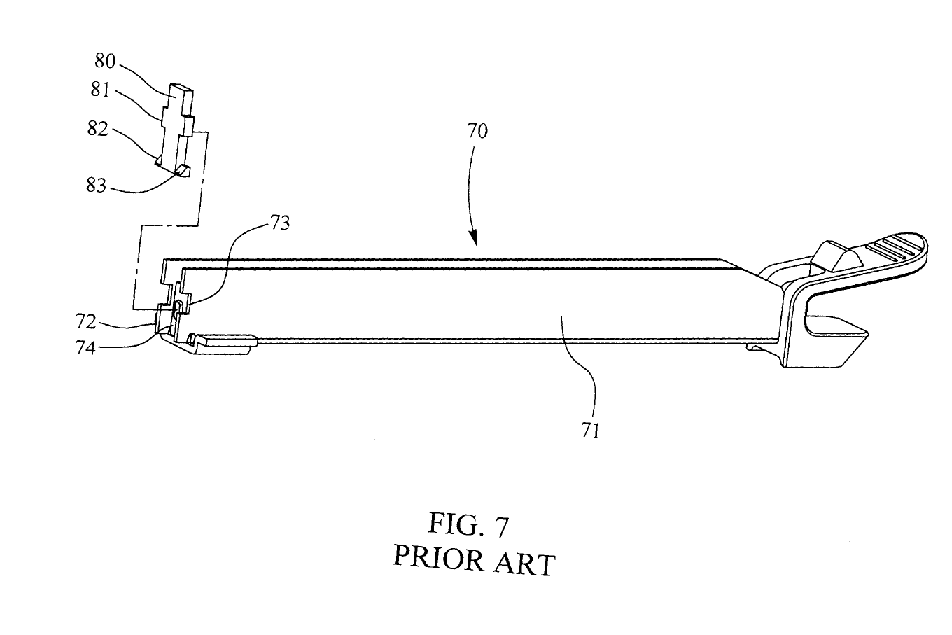

FIG. 8 is a perspective view to show the conventional staple cartridge.

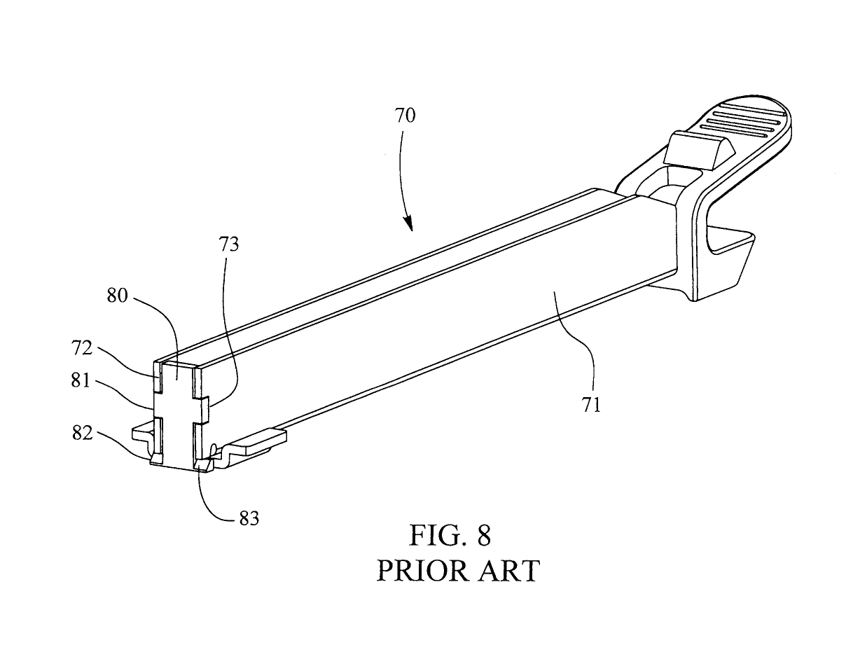

### DETAILED DESCRIPTION OF THE PREFERRED EMBODIMENT

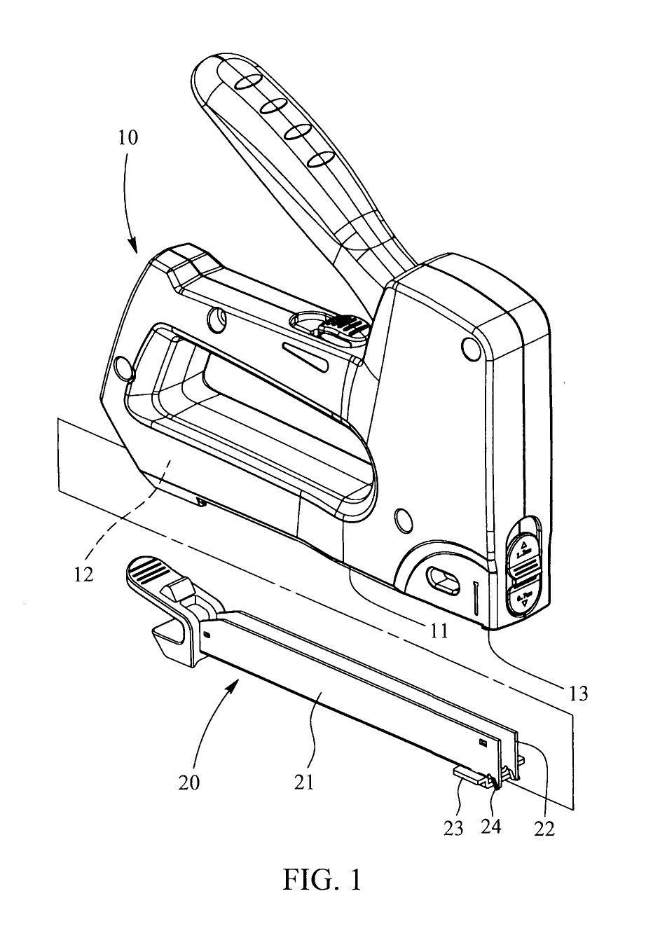

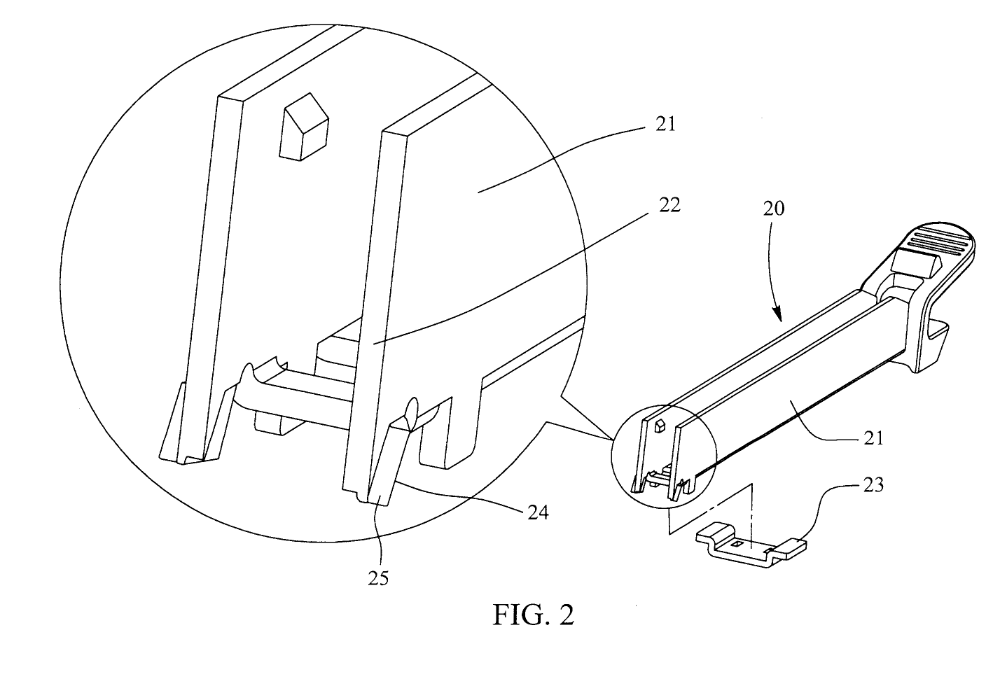

Referring to FIGS. 1 and 2, the tacker 10 includes a flat working portion 11 on the underside thereof so as to press on the object to be stapled, and a slot 12 is defined in the working portion 11 to receive the staple cartridge 20 therein. An outlet 13 is defined in the outer end of the working portion 11 and the staples are ejected from the outlet 13.

The staple cartridge 20 of the present invention comprises two side plates 21 with a bottom plate connected between the two side plates 21 to form the U-shaped staple cartridge 20. Each side plate 21 has a front end 22 and a support 23 is formed the lower end of each side plate 21.

A guide portion 24 protrudes from outside of the front end 22 of each side plate 21 so as to guide the staples on the side plates 21 to be ejected in straight. Each guide portion 24 has a guide face 25 facing toward the front direction of the side plate 21. The guide face 25 of each guide portion 24 is an inclined face relative to the front end 22. In this embodiment, each guide portion 24 is a triangular prism. The lower end of each guide portion 24 is in flush with the front end 22 corresponding thereto.

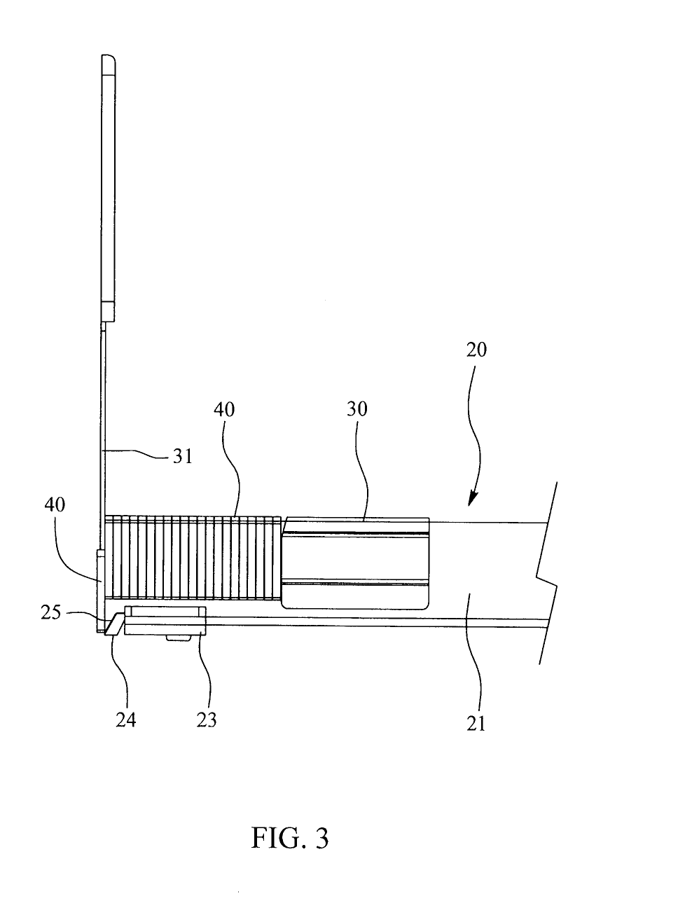

As shown in FIG. 3, the long staples 40 are mounted to the two side plates 21 of the staple cartridge 20 and the long staples 40 are biased by a pushing member 30 which pushes the long staples 40 toward the outlet 13. When the striking plate 31 is moved downward to eject the long staple 40 along the front ends 22 of the side plates 21 to staple an object. The legs of the long staples 40 are designed corresponding to the side plates 21 so that the distance between the legs of the long staples 40 and the object is short, so that the long staples 40 are guided by the guide faces 25 and quickly staple the object.

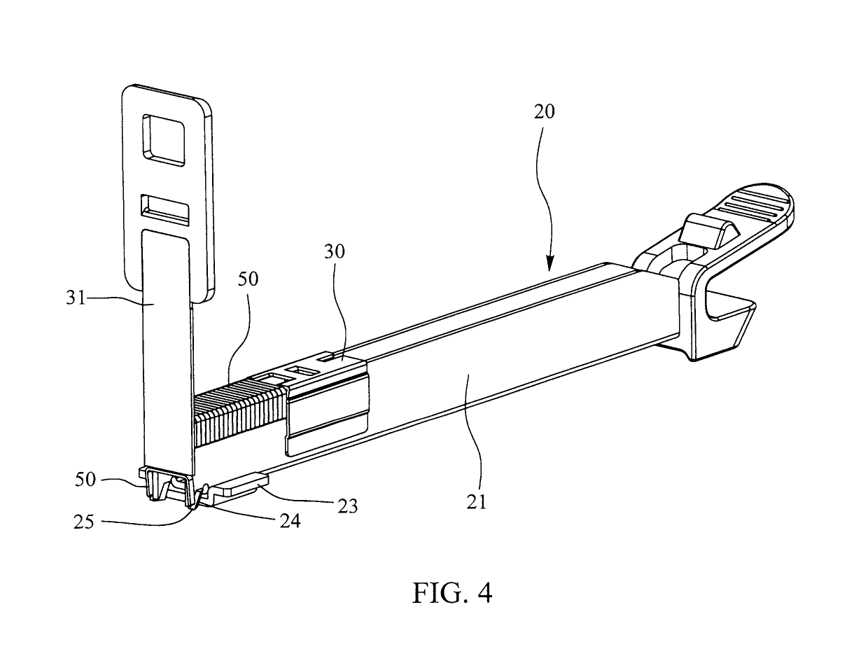

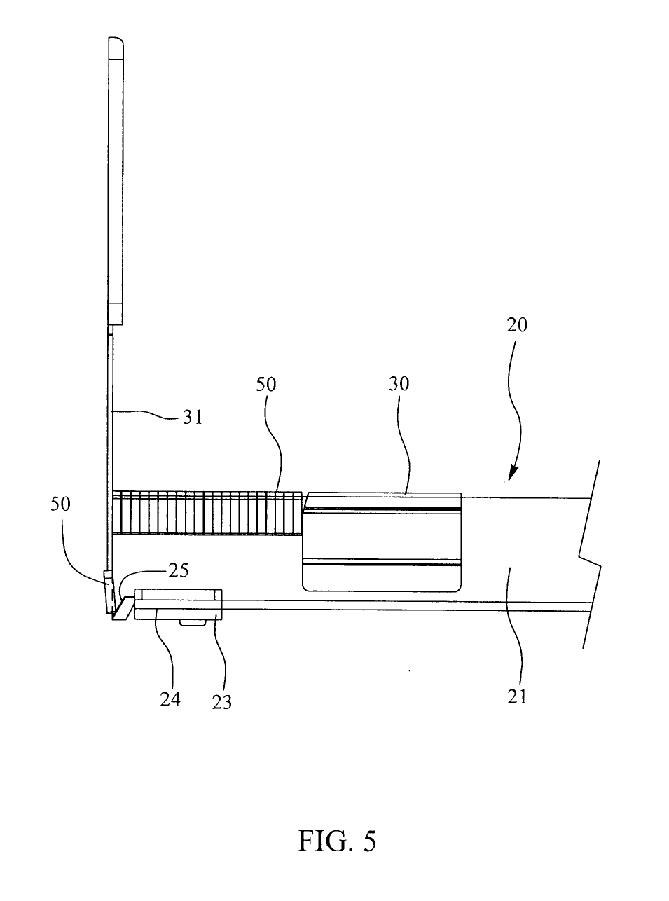

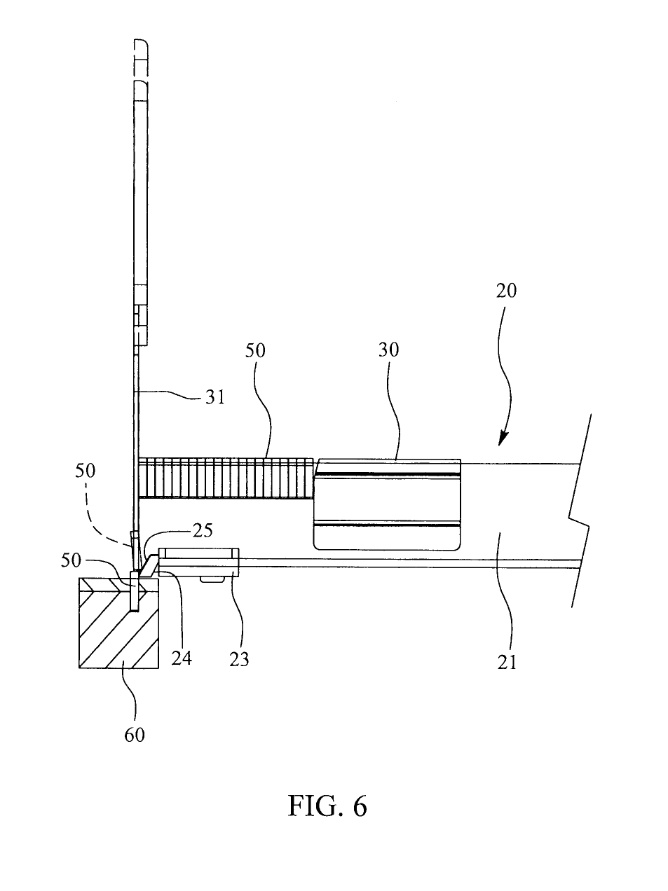

As shown in FIGS. 4 to 6, when using short staples 50, there is a longer distance between the legs of the short staples 50 and the lower ends of the side plates 21, so that when the short staples 50 are pushed by the pushing member 30 toward the outlet 13 and the short staples 50 are ejected by the striking plate 31, the travel distance that the short staples 50 move is longer than that of the long staples 40, the legs of the short staples 50 first contact the guide faces 25 of the guide portions 24 and the short staples 50 are guided to move straight to be stapled the object 60. The guide portions 24 together with the guide faces 25 ensure that the short staples 50 do not tilt during the travel when being stricken by the striking plate 31.

The staple cartridge 20 of the present invention provides two guide portions 24 to guide the short staples 50 to be ejected in straight and improve the quality of stapling.

While we have shown and described the embodiment in accordance with the present invention, it should be clear to those skilled in the art that further embodiments may be made without departing from the scope of the present invention.

What is claimed is:

1. A staple cartridge for a tacker, comprising:
two side plates with a bottom plate connected between the two side plates to form a U-shaped staple cartridge, each side plate having a front end and each front end having a guide portion protruding from outside thereof, each guide portion having a guide face facing toward a front direction of the side plate.

2. The staple cartridge as claimed in claim 1, wherein the guide face of each guide portion is an inclined face relative to the front end.

3. The staple cartridge as claimed in claim 2, wherein each guide portion is a triangular prism.

4. The staple cartridge as claimed in claim 3, wherein a lower end of each guide portion is in flush with the front end corresponding thereto.
